(19) United States
(12) Patent Application Publication
(10) Pub. No.: US 2010/0063885 A1
(43) Pub. Date: Mar. 11, 2010

(54) APPARATUS, SYSTEM, AND METHOD FOR ADVERTISEMENT COMPLEXITY SCALING VIA TRAFFIC ANALYSIS

(75) Inventors: Aaron E. Merkin, Round Rock, TX (US); William G. Pagan, Durham, NC (US)

Correspondence Address: KUNZLER & ASSOCIATES, 8 EAST BROADWAY, SUITE 600, SALT LAKE CITY, UT, 84111, US

(73) Assignee: INTERNATIONAL BUSINESS MACHINES CORPORATION, Armonk, NY (US)

(21) Appl. No.: 12/206,549

(22) Filed: Sep. 8, 2008

(51) Int. Cl. G06Q 30/00

(52) U.S. Cl. 705/14.68

(57) ABSTRACT

An apparatus, system, and method are disclosed for advertisement complexity scaling via traffic analysis. A motion module receives movement information from one or more sensors. The movement information comprises information relating to a speed of one or more people relative to an advertisement display device. A complexity module maintains an advertisement complexity rating for each of a plurality of advertisements. The advertisement complexity rating is based on an estimated viewing time of each advertisement. An advertisement selection module selects an advertisement from the plurality of advertisements based on the movement information and the advertisement complexity rating of the advertisement. The advertisement selection module correlates the speed of the one or more people relative to the advertisement display device with the advertisement complexity rating such that a higher speed correlates to a lower advertisement complexity rating. A display module displays the advertisement on a display device.

### BACKGROUND

1. Field of the Invention

This invention relates to advertising and more particularly relates to the optimized display of advertisements.

2. Description of the Related Art

As advertisement display technology improves, and as advertisement display prices decrease, advertising is increasing in both type and pervasiveness. Electronic advertisement displays are becoming more common as billboards along roads and on buildings, on the exterior of busses and taxis, as in-store displays, in athletic arenas, and in hallways at malls and in airports. Some advertisements on these displays have static text or images, while others have dynamic videos, text, or slideshows.

Advertisers often miss opportunities to connect with viewers by displaying advertisement types that are not optimized for current conditions. In dynamically changing environments, it may be difficult to decide what type of advertisement to display. For example, along a busy roadway, a video advertisement may be well suited for bumper-to-bumper traffic during rush-hour, but may have little meaning for drivers passing it at freeway speeds during other times of day. Similarly, an opportunity to play a video advertisement may be wasted by a traditional static billboard on the side of a bus, when the bus is stopped at a stoplight.

### BRIEF SUMMARY

From the foregoing discussion, it should be apparent that a need exists for an apparatus, system, and method that scale displayed advertisements based on traffic analysis. Beneficially, such an apparatus, system, and method would display an advertisement based on viewer movement information and on an advertisement complexity.

The present invention has been developed in response to the present state of the art, and in particular, in response to the problems and needs in the art that have not yet been fully solved by currently available advertising displays. Accordingly, the present invention has been developed to provide an apparatus, system, and method for displaying advertisements that overcome many or all of the above-discussed shortcomings in the art.

The apparatus to display an advertisement is provided with a plurality of modules configured to functionally execute the necessary steps of advertisement complexity scaling via traffic analysis. These modules in the described embodiments include a motion module, a complexity module, an advertisement selection module, and a display module.

The motion module, in one embodiment, receives movement information from one or more sensors. In one embodiment, the movement information comprises information relating to a speed of one or more people relative to an advertisement display device. In a further embodiment, the one or more sensors include movement detecting sensors. The one or more people, in one embodiment, include one or more pedestrians. The one or more people, in a further embodiment, include vehicle occupants. In another embodiment, the speed of the one or more people relative to the advertisement display device comprises a moving speed of the advertisement display device.

In one embodiment, the complexity module maintains an advertisement complexity rating for each of a plurality of advertisements. Each advertisement of the plurality of advertisements, in one embodiment, is formatted for display on the advertisement display device. In another embodiment, the plurality of advertisements includes advertisements of static and dynamic data types. In one embodiment, the static data type includes an image data type, and the dynamic data type includes a video data type.

In one embodiment, the advertisement complexity rating is based on an estimated viewing time of each advertisement of the plurality of advertisements such that an advertisement with a low estimated viewing time has a lower complexity rating than an advertisement with a higher estimated viewing time. In one embodiment, the estimated viewing time is based on a duration of the advertisement. The estimated viewing time, in another embodiment, is based on an amount of text in the advertisement. In a further embodiment, the estimated viewing time is based on a data type of the advertisement.

The advertisement selection module, in one embodiment, selects an advertisement from the plurality of advertisements in response to the motion module receiving movement information. In a further embodiment, the advertisement selection module selects the advertisement based on the received movement information and on the advertisement complexity rating of the advertisement. In another embodiment, the advertisement selection module correlates the speed of the one or more people relative to the advertisement display device with the advertisement complexity rating such that a higher speed correlates to a lower advertisement complexity rating. In a further embodiment, the advertisement selection module selects an advertisement with an appropriate complexity rating with respect to the received movement information.

In one embodiment, the display module displays the advertisement that the advertisement selection module selects on the advertisement display device. In another embodiment, the display module displays the advertisement in response to the advertisement selection module selecting the advertisement.

A system of the present invention is also presented to display an advertisement. The system may be embodied by an advertisement repository, an electronic advertisement display device, one or more movement detecting sensors, and an advertisement control module. In particular, the system, in one embodiment, includes a vehicle to which the display device is coupled.

The one or more sensors, in one embodiment, may be selected from the group comprising a radar sensor, a light detection and ranging sensor, an optical sensor, and an inductive sensor. In a further embodiment, at least one of the one or more sensors includes a speedometer.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for advertisement complexity scaling via traffic analysis in accordance with the present invention;

FIG. 2 is a schematic block diagram illustrating one embodiment of an advertisement control module in accordance with the present invention; and

FIG. 3 is a schematic flow chart diagram illustrating one embodiment of a method for advertisement complexity scaling via traffic analysis in accordance with the present invention.

### DETAILED DESCRIPTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, include one or more physical or logical blocks of computer instructions which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable media.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a computer readable medium may take any form capable of storing machine-readable instructions on a digital processing apparatus. A computer readable medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

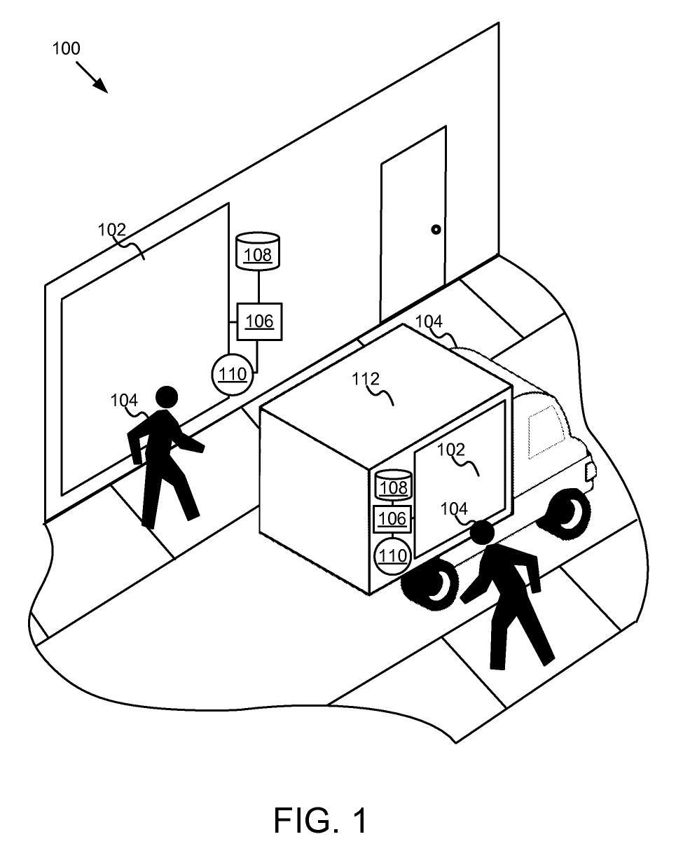

FIG. 1 depicts one embodiment of a system 100 for advertisement complexity scaling via traffic analysis. The system 100, in the depicted embodiment, includes a display device 102, one or more viewers 104, an advertisement control module 106, an advertisement repository 108, one or more sensors 110, and a vehicle 112.

In one embodiment, the display device 102 is an electronic advertisement display device configured to display visual advertisements. The display device 102 may comprise an electronic display device, such as a light emitting diode (“LED”) display, a liquid crystal display (“LCD”), a plasma display, a cathode ray tube (“CRT”) display, a projection display, an organic LED (“OLED”) display, a surface-conduction electron-emitter display (“SED”), a field emission display (“FED”), an electronic paper display, or another type of electronic display device.

In one embodiment, the display device 102 is configured to display static advertisements and/or dynamic advertisements. Static advertisements, in one embodiment, may include images, text, and/or other static advertising elements. In one embodiment, dynamic advertisements may include video, moving text, moving images, slideshows, animations, and/or other dynamic advertising elements. The display device 102, in one embodiment, is configured to display a plurality of advertisements from the advertisement repository 108.

In one embodiment, the display device 102 is freestanding. In another embodiment, the display device is mounted on or otherwise coupled to a preexisting structure such as a wall or the like. In a further embodiment, the display device 102 is mounted on or otherwise coupled to a vehicle. For example, in different embodiments, the display device 102 may include a billboard, a marquee, an interior or exterior store display, a taxi-mounted advertising display, a bus-mounted advertising display, a train-mounted advertising display, a truck-mounted advertising display, or another type of display.

The one or more viewers 104, in one embodiment, include bystanders, pedestrians, cyclists, vehicle occupants, and/or other people within viewing distance of the display device 102. In a further embodiment, the one or more viewers 104 may be disposed within a sensing range of the one or more sensors 110.

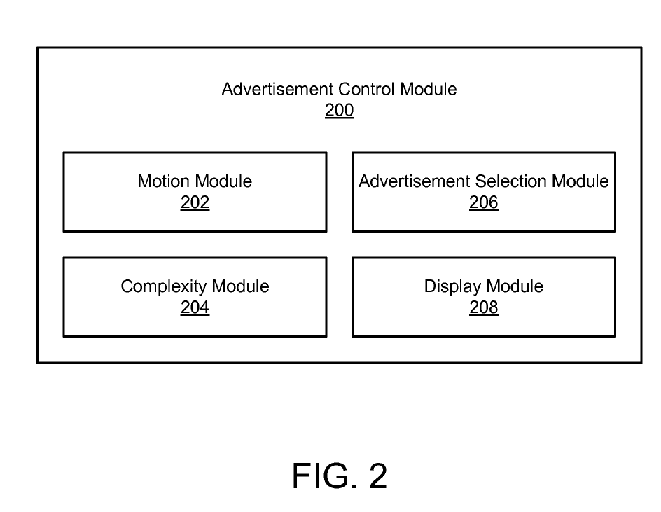

One embodiment of the advertisement control module 106 is described in greater detail with regard to the advertisement control module 200 of FIG. 2. In general, the advertisement control module 106 displays advertisements from the advertisement repository 108 on the display device 102 based on information from the one or more sensors 110 and on advertisement complexities of the advertisements. Advertisement complexities may be based on an estimated viewing time of the advertisement, on a duration of the advertisement, on an amount of text in the advertisement, on a data type of the advertisement, or on other complexity factors.

In one embodiment, the advertisement repository 108 includes an electronic storage device that is configured to store a two or more advertisements. The two or more advertisements are formatted for display on the display device 102. The two or more advertisements, in one embodiment, may include static advertisements and/or dynamic advertisements, as described above with regard to the display device 102. In a further embodiment, the advertisement repository 108 is configured to store an advertisement complexity rating for each advertisement in the plurality of advertisements.

In one embodiment, the one or more sensors 110 are configured to determine movement information, and may include movement detecting sensors. In one embodiment, the movement information includes viewing time information of the one or more viewers 104. Viewing time information, in one embodiment, may include speed information, directional information, movement path information, traffic information, distance information, and/or other information relating to a viewing time of the display device 102. In another embodiment, the movement information includes information relating to a speed of the one or more viewers 104 relative to the display device 102. The speed of the one or more viewers 104 relative to the display device 102 may comprise a speed of moving viewers 104, a speed of a moving display device 102, or a difference in speeds of moving viewers 104 and a moving display device 102.

In another embodiment, the movement information includes pedestrian traffic flow information, such as a speed of one or more pedestrian members of the viewers 104. The movement information, in a further embodiment, includes vehicle traffic flow information, such as a speed of the vehicle 112 and/or other passing vehicles. In one embodiment, the one or more sensors 110 may be directed toward or calibrated for a predetermined area and/or a predetermined type of passing viewer. For example, the one or more sensors 110 may be directed toward or calibrated for pedestrian traffic, vehicular traffic, or another type of traffic. In one embodiment, the one or more sensors 110 may include one or more of radar sensors, light detection and ranging (“LIDAR”) sensors, optical sensors, inductive sensors, and/or other sensor types.

In one embodiment, the display device 102 is coupled to the vehicle 102, and the movement information includes a speed of the display device 102. In a further embodiment, at least one of the one or more sensors 110 may include a speedometer of the vehicle 112, or another speedometer type sensor coupled to the display device 102 or to the vehicle 112. In another embodiment, the one or more sensors 110 include a speedometer type sensor to determine a speed of the display device 102 and one or more other sensors to determine movement information of viewers such as other vehicles, pedestrians, and the like.

The vehicle 112, in one embodiment, may include one of the one or more viewers 104. In a further embodiment, the display device 102, the advertisement control module 106, and the advertisement repository 108 are coupled to the vehicle 112. The vehicle 112, in one embodiment, may include a bus, a train, a taxi, a truck, a car, a boat, an aircraft, or another vehicle type capable of bearing the display device 102 and visible to the one or more viewers 104.

FIG. 2 illustrates one embodiment of an advertisement control module 200. In one embodiment, the advertisement control module 200 is substantially similar to the advertisement control module 106 of FIG. 1. In the depicted embodiment, the advertisement control module 200 includes a motion module 202, a complexity module 204, an advertisement selection module 206, and a display module 208, which are described below.

In one embodiment, the motion module 202 is configured to receive movement information from one or more sensors, such as the one or more sensors 110 of FIG. 1. The movement information, in one embodiment, may include information relating to a speed of one or more people relative to an advertisement display device, viewing time information such as pedestrian traffic flow information, vehicle traffic flow information, or the like. In a further embodiment, the movement information may include a speed of a display device, such as the display device 102 of FIG. 1.

The complexity module 204, in one embodiment, is configured to maintain an advertisement complexity rating for each of a plurality of advertisements. In one embodiment, the advertisement complexity rating may be based on an estimated viewing time of each advertisement of the plurality of advertisements. In another embodiment, an advertisement with a low estimated viewing time has a lower complexity rating than an advertisement with a higher estimated viewing time. The estimated viewing time may be based on a duration of an advertisement, with longer advertisements receiving higher advertisement complexities, on an amount of text in an advertisement, with advertisements with more text receiving higher advertisement complexities, on a data type of an advertisement, such as static and dynamic data types, or on other viewing time or complexity factors. Dynamic data types, such as video data types and the like, may receive higher advertisement complexities than static data types, such as static image data types or text data types. In one embodiment, a data type of an advertisement may be determined by a file extension, metadata, header data, or the like of an advertisement data file. In a further embodiment, the advertisement complexity rating and or the estimated viewing time may be based on a combination of a plurality of the above factors and/or other factors.

In one embodiment, the plurality of advertisements is stored in an advertisement repository, such as the advertisement repository 108 of FIG. 1. In another embodiment, an advertisement complexity rating, complexity indicator, or the like for each advertisement of the plurality of advertisements is stored with the plurality of advertisements. In a further embodiment, the plurality of advertisements are organized or named according to advertisement complexity rating. For example, in one embodiment, advertisement files may include names, file extensions, or the like that indicate complexity, may be organized in folders or storage location based on complexity, or may otherwise include advertisement complexity rating indicating information. The complexity module 204, in one embodiment, may determine the advertisement complexities itself, or in another embodiment, may use predefined advertisement complexities.

In one embodiment, the advertisement selection module 206 is configured to select an advertisement from the plurality of advertisements from the complexity module 204. The advertisement selection module 206 may select an advertisement in response to the motion module 202 receiving movement information. The advertisement selection module 206, in one embodiment, bases the selection on the movement information received from the motion module 202 and on the advertisement complexity rating of the advertisement from the complexity module 204.

The advertisement selection module 206 selects an advertisement with an appropriate complexity rating with respect to the received movement information. In one embodiment, the advertisement selection module 206 correlates a higher speed from the movement information with a lower advertisement complexity rating. In another embodiment, the advertisement selection module 206 is configured to use a round robin selection method, a random selection method, a prioritized selection method, or another selection method to select an advertisement from a plurality of advertisements having similar advertisement complexities.

The advertisement selection module 206, in another embodiment, may use one or more advertisement complexity scales, threshold values, or the like, to match an advertisement having an advertising complexity to movement information. In one embodiment, the advertisement selection module 206 selects an advertisement having a predefined advertisement complexity rating in response to movement information above a predefined level, and selects an advertisement having another predefined advertisement complexity rating in response to movement information below the predefined level. The advertisement selection module 206, in one embodiment, may select an advertisement having a lower advertisement complexity rating, such as a static advertisement, in response to movement information above a predefined threshold value, such as a faster traffic flow or faster vehicle speed, and selects an advertisement having a higher advertisement complexity rating, such as a dynamic advertisement, in response to movement information below the predefined threshold value, such as a slower traffic flow or lower vehicle speed.

The display module 208, in one embodiment, is configured to display the advertisement that the advertisement selection module 206 selects on a display device, such as the display device 102 of FIG. 1. The display module 208 may display the advertisement that the advertisement selection module 206 selects in response to the advertising selection module 206 selecting the advertisement. In a further embodiment, the display module 208 may include an advertisement queue configured to store one or more upcoming advertisements that the advertisement selection module 206 selects.

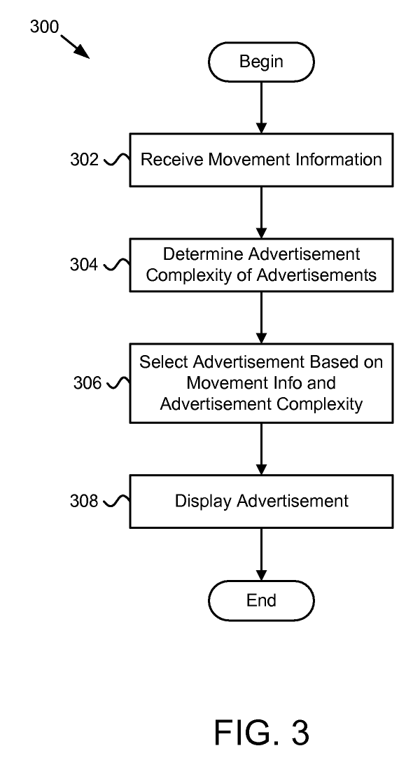

FIG. 3 illustrates one embodiment of a method 300 for advertisement complexity scaling via traffic analysis. The method 300 begins and the motion module 202 receives 302 movement information from the one or more sensors 110. The complexity module 204 determines 304 an advertisement complexity rating for each advertisement from the plurality of advertisements stored in the advertisement repository 108.

The advertisement selection module 206 selects 306 an advertisement from the plurality of advertisements stored in the advertisement repository 108 based on the movement information that the motion module 202 received 302 from the one or more sensors 110 and on the advertisement complexity rating that the complexity module 204 determined 304 for the advertisement. The display module 208 displays 308 the advertisement that the advertisement selection module 206 selected 306 on the display device 102 and the method 300 ends.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to display an advertisement, the apparatus comprising:
a motion module configured to receive movement information from one or more sensors, wherein the movement information comprises information relating to a speed of one or more people relative to an advertisement display device, and further wherein the one or more sensors comprise movement detecting sensors;
a complexity module configured to maintain an advertisement complexity rating for each advertisement of a plurality of advertisements, wherein each advertisement of the plurality of advertisements is formatted for display on the advertisement display device and the advertisement complexity rating is based on an estimated viewing time of each advertisement of the plurality of advertisements such that an advertisement with a low estimated viewing time has a lower complexity rating than an advertisement with a higher estimated viewing time;
an advertisement selection module configured to select an advertisement from the plurality of advertisements in response to the motion module receiving the movement information, wherein the advertisement selection module selects an advertisement based on the received movement information and the advertisement complexity rating of the advertisement, the advertisement selection module correlating the speed of the one or more people relative to the advertisement display device with the advertisement complexity rating such that a higher speed correlates to a lower advertisement complexity rating and the advertisement selection module selects an advertisement with an appropriate complexity rating with respect to the received movement information; and
a display module configured to display the advertisement that the advertisement selection module selects on the advertisement display device in response to the advertising selection module selecting the advertisement.

2. The apparatus of claim 1, wherein the estimated viewing time is based on a duration of the advertisement.

3. The apparatus of claim 1, wherein the estimated viewing time is based on an amount of text in the advertisement.

4. The apparatus of claim 1, wherein the estimated viewing time is based on a data type of the advertisement.

5. The apparatus of claim 4, wherein the plurality of advertisements comprises advertisements of static and dynamic data types.

6. The apparatus of claim 5, wherein the static data type comprises an image data type, and wherein the dynamic data type comprises a video data type.

7. The apparatus of claim 1, wherein the one or more people comprise one or more pedestrians.

8. The apparatus of claim 1, wherein the one or more people comprise vehicle occupants.

9. The apparatus of claim 1, wherein the speed of the one or more people relative to the advertisement display device comprises a moving speed of the advertisement display device.

10. A system to display an advertisement, the system comprising:
an advertisement repository configured to store a plurality of advertisements comprising static advertisements and dynamic advertisements;
an electronic advertisement display device configured to display the plurality of advertisements;
one or more movement detecting sensors configured to determine movement information of one or more viewers, wherein the movement information comprises information relating to a speed of one or more people relative to the electronic advertisement display device; and
an advertisement control module configured to maintain an advertisement complexity rating for each of the plurality of advertisements based on an estimated viewing time of each advertisement of the plurality of advertisements, to select an advertisement from the plurality of advertisements based on the movement information and on the advertisement complexity rating of the advertisement correlating the speed of the one or more people relative to the electronic advertisement display device with the advertisement complexity rating such that a higher speed correlates to a lower complexity rating, and to display the advertisement on the electronic advertisement display device.

11. The system of claim 10, wherein at least one of the one or more sensors is selected from the group comprising a radar sensor, a light detection and ranging sensor, an optical sensor, and an inductive sensor.

12. The system of claim 10, wherein at least one of the one or more sensors comprises a speedometer.

13. The system of claim 12, wherein the electronic advertisement display device is coupled to a vehicle.
